(19) United States
(12) Patent Application Publication
(10) Pub. No.: US 2008/0136979 A1
(43) Pub. Date: Jun. 12, 2008

(54) Identification Medium and Article with Identification Medium

(75) Inventors: Hidekazu Hoshino, Kanagawa (JP); Hiroyuki Matsumoto, Kanagawa (JP); Tokio Sakauchi, Kanagawa (JP); Itsuo Takeuchi, Kanagawa (JP)

Correspondence Address: OLIFF & BERRIDGE, PLC, P.O. BOX 320850, ALEXANDRIA, VA, 22320-4850, US

(73) Assignee: NHK SPRING CO., LTD., YOKOHAMA-SHI (JP)

(21) Appl. No.: 11/795,884

(22) PCT Filed: Feb. 3, 2006
(86) PCT No.: PCT/JP2006/301868

§ 371 Date: Jul. 24, 2007

(30) Foreign Application Priority Data
Feb. 7, 2005 (JP) 2005-030640

(51) Int. Cl. G02F 1/13

(52) U.S. Cl. 349/1

(57) ABSTRACT

An identification medium 101 has a stacked structure comprising a fabric 102, an ordinary printed layer 103 of an ordinary black ink, and an identification layer 104 of an ink including cholesteric liquid crystals. A predetermined printed character is formed by the identification layer 104, whereby a print display utilizing optical characteristics of cholesteric liquid crystals is formed. The ordinary printed layer 103 functions as a flattening layer to smooth the asperity of the fabric 102, whereby optical characteristics of the identification layer 104 is effectively performed. Thus, the identification medium 101 is comprised of the fabric 102 as a substrate, whereby the design of articles such as garments and accessories is not spoiled and discomfort is not caused.

### TECHNICAL FIELD

The present invention relates to an identification medium that allows determination of whether or not articles are authentic by use of visual effects.

### BACKGROUND ART

Counterfeits of articles (for example, garments, accessories such as handkerchiefs, shoes, and bags), which are produced by copying the appearances of authentic articles, are being sold, and they cause problems. Under these circumstances, in order to ensure performance, reliability and security of articles and to maintain the worthiness of the brands of articles, techniques for verifying the authenticity of the articles are required.

An identification medium that has a specific appearance may be used as a method for determining the authenticity of an article. For example, an identification medium having a function of showing a hologram, and an identification medium using optical characteristics of cholesteric liquid crystals are known. For example, an identifying function using the cholesteric liquid crystal is disclosed in Japanese Unexamined Patent Application Publications Nos. 63-51193 and 4-144796.

The design of the above garments and accessories is very important. Therefore, it may be undesirable to affix a piece of the above identification medium thereon. A conventional identification medium is affixed to an article by using a setting adhesive layer or an adhesive layer such as a seal. However, the identification medium having a seal structure is difficult to affix to textiles such as garments.

### DISCLOSURE OF THE INVENTION

An object of the present invention is to provide an identification method for determining authenticity in which an identification medium can be affixed to textiles without spoiling the design thereof, and there is no discomfort due to articles such as garments and accessories.

The present invention provides an identification medium comprising a woven or nonwoven fabric and an identification layer that is printed using an ink including cholesteric liquid crystals on the fabric. According to the present invention, a fabric provided with an identification portion which shows an optical characteristic of cholesteric liquid crystals is obtained.

According to the present invention, the identification medium is comprised of a fabric as a substrate, whereby the design of articles such as textiles is not spoiled. Moreover, there is no discomfort when the identification medium is used with textiles. Specifically, an identifying ability is provided to a conventional fabric label by employing the present invention.

An ink including cholesteric liquid crystals (liquid crystal ink) is formed by dispersing a cholesteric liquid crystal layer, which is cut into scale-like pieces, into a vehicle of an ordinary ink. An ordinary ink is defined as an ink for printing.

When an ink including cholesteric liquid crystals is printed in layers, the scale-like cholesteric liquid crystal layer is distributed in layers and a function of a cholesteric liquid crystal layer is performed. When an ink including cholesteric liquid crystals is used, a layer which performs a function of a cholesteric liquid crystal layer is formed by printing.

Cholesteric liquid crystals are processed into pigments in powder form, and are dispersed into an ink solvent, so that an ink including cholesteric liquid crystals is obtained. Products produced by Wacker Chemie GmbH are known as pigments in powder form of cholesteric liquid crystals.

In the identification medium of the present invention, a structure is preferably provided with an ordinary printed layer that shows a predetermined color between an identification layer and a fabric.

As mentioned hereinafter, the cholesteric liquid crystal layer has an optical characteristic in which light having a predetermined rotation direction and a predetermined wavelength is reflected, and the rest of the light is transmitted therethrough. An identifying ability is performed by utilizing this optical characteristic.

In the optical function, identification is performed by viewing reflected light from the cholesteric liquid crystal layer. Therefore, in order to obtain a good identifying ability, light transmitted through the cholesteric liquid crystal layer is required to be partially absorbed by the background (the base side of the cholesteric liquid crystal).

The above ordinary printed layer is provided between a fabric and an identification layer, and the color of the ordinary printed layer may be appropriately selected, so that the above requirements are satisfied. For example, as an ink forming the ordinary printed layer, a black ink or a dark-colored ink is used, so that the ordinary printed layer functions as a light absorption layer (a layer which absorbs visible light).

The above ordinary printed layer functions as a flattening layer that moderates asperity of a fabric. That is, the surface of the fabric has asperity of which the size is approximately the fiber diameter, because the fabric is made of fibers. If an identification layer is directly printed on a fabric by using an ink including cholesteric liquid crystals, a stacked structure of the identification layer is greatly affected by the asperity of the fabric. That is, the cholesteric liquid crystal layer is spread along the asperity of the fabric.

The identification layer comprises a fine structure in which a scale-like cholesteric liquid crystal layer is distributed in layers, whereby the scale-like cholesteric liquid crystal layer is spread in undulating layers if the stacked structure is undulated. Therefore, each optical axis of scale-like cholesteric liquid crystal layers (an axis perpendicular to the cholesteric liquid crystal layer) varies along with the undulating stacked structure. That is, when the identification layer is viewed from a viewing angle of 0°, each optical axis of the many cholesteric liquid crystal pieces distributed in the identification layer varies along with the structure of the undulating form.

As a result, visual effects of the cholesteric liquid crystal, which are described below, are decreased. That is, the optical characteristics of the cholesteric liquid crystal are not substantial.

When an ordinary printed layer is provided as a flattening layer between a fabric and an identification layer, the ordinary printed layer smoothes the asperity of the fabric. Therefore, the asperity of the fabric does not greatly affect the identification layer. Accordingly, although a fabric may be used as a substrate, the visual effects of the cholesteric liquid crystal are distinct. That is, when a fabric is applied as a substrate, optical characteristics of the cholesteric liquid crystal are obtained.

In the identification medium of the present invention, a fabric label is preferably made of a fabric. A fabric label is a small piece of fabric that indicates a brand name, a size, instructions for washing, etc., on articles such as garments. Discriminating ability is provided to an article without spoiling the design thereof by applying the present invention to a fabric label. That is, an identifying ability obtained by cholesteric liquid crystals can be provided to a conventional fabric label. Note that a fabric label on which information is printed is called a “printed name tag”, whereas one on which information is embroidered is called a “woven name tag”.

In the identification medium of the present invention, a fabric may be embroidered. According to this aspect, an identifying ability is provided by a visual effect of cholesteric liquid crystals combined with a visual effect of embroidery.

In the identification medium of the present invention, a printed layer using a thermochromic ink or a photochromic ink may be used as an ordinary printed layer. When an ordinary printed layer is comprised of a thermochromic ink or a photochromic ink, a change in optical characteristics performed by heating and light irradiation is observed. Accordingly, the identifying ability is further improved.

The present invention may be explained as an article provided with the above identification medium. As articles, garments, accessories, shoes, bags, stuffed animals, purses, and other textiles may be mentioned. As accessories, handkerchiefs, socks, gloves, hats, and neckties may be mentioned.

A cholesteric liquid crystal is explained as follows. FIG. 3 is a schematic view for showing a structure of cholesteric liquid crystal layers, and FIG. 4 is a schematic view for explaining optical characteristics of a cholesteric liquid crystal layer. FIG. 4 shows a condition in which a right-handed circularly polarized light having a predetermined wavelength is reflected, and a left-handed circularly polarized light, a linearly polarized light, and right-handed circularly polarized light having other wavelengths are transmitted through a cholesteric liquid crystal layer 201 when natural light enters into the layer.

The cholesteric liquid crystal layer has a stacked structure. In one layer, long axes of liquid crystal molecules have the same orientation and are parallel to the plane thereof in a layer. The directions of the orientation differ with respect to the adjacent layer in the direction of layer thickness, and the layers are stacked with the orientations rotated in a three-dimensional spiral structure overall.

In this structure, in a direction perpendicular to the layer, pitch P is a distance necessary for the molecular long axis to be rotated through 360° and return to the initial state, and an average refraction index of the respective layers is index n. In this case, the cholesteric liquid crystal layer selectively reflects circularly polarized light having a center wavelength λs and a predetermined rotation direction satisfying the equation λs=n×P. That is, when white light enters into the cholesteric liquid crystal layer, a right-handed or left-handed circularly polarized light having a predetermined center wavelength is selectively reflected. In this case, circularly polarized light having the same rotation direction as the reflected circularly polarized light but not having the wavelength of λs, a circularly polarized light having a reverse rotation direction to the reflected circularly polarized light, and a linearly polarized light are transmitted through the cholesteric liquid crystal layer.

The rotation direction (rotating direction) of the reflected circularly polarized light is determined by selecting a spiral direction of the cholesteric liquid crystal layer. That is, when the molecular long axes are viewed from the incident direction of the light, by selecting either the spiral direction in which the molecular long axis of each layer orientation is clockwise or is counterclockwise, the rotation direction (rotating direction) of the reflected circularly polarized light is determined.

The cholesteric liquid crystal exhibits an optical characteristic called “color shifting” in which the color changes according to the viewing angle. The reason for this is that the pitch P is apparently decreased when the viewing angle is increased, and the center wavelength Xs shifts toward shorter wavelengths. For example, a reflected color of a cholesteric liquid crystal appears red when the cholesteric liquid crystal is observed from the perpendicular direction, and it shifts to orange, yellow, green, blue green, blue in turn according to the increase of the viewing angle. It should be noted that the viewing angle is defined as an angle formed by a visual line and a vertical line relative to the surface of the identification medium.

According to the present invention, an identification medium is formed by using cholesteric liquid crystals and a fabric as a substrate. Therefore, an identification method for determining authenticity is provided without spoiling the design of textiles, and there is no discomfort due to articles such as garments and accessories.

### BRIEF DESCRIPTION OF DRAWINGS

FIG. 1 is a cross section view for showing a cross sectional structure of an identification medium of the present invention.

FIG. 2 is a schematic view for showing an identification medium of the present invention that is observed from the front side.

FIG. 3 is a schematic view for showing a stacked structure of a cholesteric liquid crystal layer.

FIG. 4 is a schematic view for explaining the optical characteristics of a cholesteric liquid crystal layer.

### EXPLANATION OF REFERENCE NUMERALS

101 denotes an identification medium, 102 denotes a fabric, 103 denotes an ordinary printed layer, 104 denotes an identification layer, and 201 denotes a cholesteric liquid crystal layer.

### BEST MODE FOR CARRYING OUT THE INVENTION

### 1. First Embodiment

### Composition of Embodiment

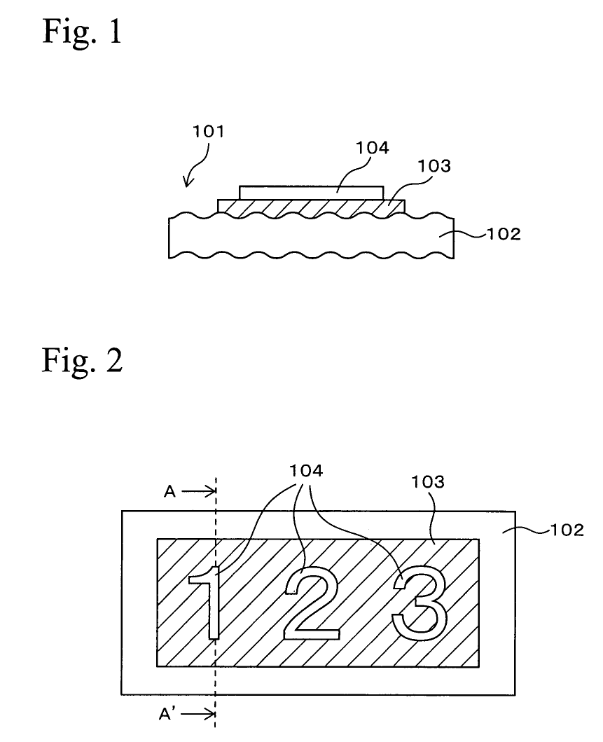

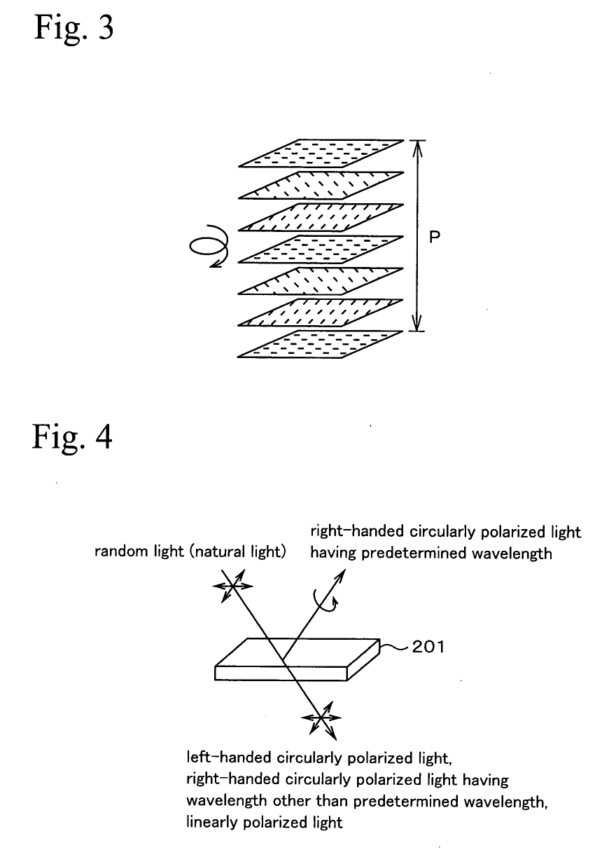

FIG. 1 is a cross section view for showing a cross section structure of an identification medium of the present invention. FIG. 2 is a front side view of the identification medium shown in FIG. 1. It should be noted that a cross section taken on line A-A′ of FIG. 2 is the cross section view shown in FIG. 1.

The identification medium 101 shown in FIG. 1 comprises a fabric 102, an ordinary printed layer 103, and an identification layer 104. In this example, the identification medium 101 forms a fabric label which is sewn on a garment. Moreover, in this example, as shown in FIG. 2, a printed display “1 2 3” is formed by the identification layer 104.

The fabric 102 is a substrate of a fabric label of a woven fabric made from synthetic fiber. A fabric forming an ordinary fabric label may be used for the fabric 102.

An ordinary printed layer 103 is printed on the fabric 102. The ordinary printed layer 103 is printed with an ordinary black ink. The ordinary printed layer 103 functions as a flattening layer that smoothes the asperity of the fabric 102 and forms a flattened surface.

That is, the fabric 102 is a woven fabric woven from the fibers. Therefore, the surface of the fabric 102 has an asperity of which roughness is a size of approximately the fiber diameter. The ordinary printed layer 103 smoothes the asperity and provides a flatter surface.

An identification layer 104 is formed on the ordinary printed layer 103. As shown in FIG. 2, the identification layer 104 forms a printed display of the numbers “1 2 3”. It should be noted that the content of the printing may be indicated by characters, figures, and other appropriate designs in addition to numbers.

As a liquid crystal ink forming the identification layer 104, a raw material of a liquid crystal ink (a pigment including cholesteric liquid crystal powder) produced by Wacker Chemie GmbH, which is dispersed in an ink solvent, may be used as a pigment. In the present invention, a pigment including cholesteric liquid crystal layers that selectively reflect right-handed circularly polarized light in the green is used.

The identification medium 101 explained in the present invention may be used for a fabric label, such as one that is commonly affixed to a garment (for example, shirts and suits). The fabric label has optical functions of cholesteric liquid crystals.

The identification medium 101 can be used in the same way as a conventional fabric label is used. The identification medium 101 seems to be similar to the conventional fabric label at first glance. Therefore, an identifying ability for determining authenticity is provided without spoiling the design of garments. Moreover, discomfort does not occur when the identification medium 101 is used.

### Optical Functions of Embodiment

Optical functions of the identification medium 101 shown in FIG. 1 and FIG. 2 are explained. When the identification medium 101 is observed from the front side, a display “1 2 3” of the identification layer 104 is distinctly visible in green on a black background. The reason for this is that right-handed circularly polarized light having a wavelength in the green is selectively reflected from the identification layer 104, and right-handed circularly polarized light having other wavelengths, left-handed circularly polarized light, and linearly polarized light are transmitted through the identification layer 104 and are absorbed in the ordinary printed layer 103 in black.

When the identification medium 101 is observed through an optical filter which selectively transmits right-handed circularly polarized light, the identification medium 101 looks the same as the above identification medium which is directly observed. The reason for this is that right-handed circularly polarized light in the green is reflected from the identification layer 104 and is transmitted through the optical filter, and the light is observed.

When the identification medium 101 is observed through an optical filter that selectively transmits left-handed circularly polarized right, the green display of the identification layer 104 is dark, and it is difficult to observe. That is, the contrast (contrast with the black background) of the green display that has been distinctly observed, is reduced, and an appearance without a high contrast is observed.

The reason for this is that the optical filter used in the above description selectively transmits left-handed circularly polarized light, and cuts off right-handed circularly polarized light. That is, right-handed circularly polarized light in the green is reflected from the identification layer 104 and is cut off by the optical filter.

Thus, in the identification medium 101 used as a fabric label, an identifying ability is obtained by observing through an optical filter which selectively transmits circularly polarized light having a predetermined rotation direction. By this identifying ability, a predetermined printed display is observed or is difficult to observe. The determination of the authenticity is performed by using this function. That is, even if a counterfeit having a similar appearance to that of the identification medium 101 is produced, when an observation is performed through an optical filter, the counterfeit can be determined to be a counterfeit as long as the above optical effects are not confirmed.

In the present invention, the ordinary printed layer 103 in black is explained as the simplest example. Furthermore, the identification layer 104 may be adjusted to have a specific color by setting the color of the ordinary printed layer 103 (for example, dark blue or dark red). The setting of the color requires specialized knowledge because the color relates to the fabric 102, whereby the identification medium is difficult to reproduce by appearance alone. Therefore, a counterfeit is difficult to produce. This is an advantage in an identification medium for determining authenticity.

In the present invention, an observation through an optical filter is exemplified. Moreover, light is irradiated on an identification medium through an optical filter, and reflected light may be observed. That is, right-handed or left-handed circularly polarized light is irradiated on an identification medium, and the reflected light may be observed.

### 2. Second Embodiment

According to the schematic views shown in FIG. 1 and FIG. 2, patterns or figures may be embroidered on the fabric 102. In this case, a display of embroidery sewn on the fabric 102 may be combined with a display of the identification layer 104.

### 3. Third Embodiment

A case in which the identification medium 101 shown in FIG. 1 and FIG. 2 is mounted on a necktie as a fabric label is explained hereinafter. In this case, the identification medium 101 is mounted on an inside of an end of a necktie as a fabric label.

The necktie does not seem to differ in appearance from that of a necktie on which is mounted an ordinary fabric label. However, when the fabric label is observed through an optical filter which selectively transmits circularly polarized light having a predetermined rotation direction, an identifying ability is performed by specific optical characteristics of cholesteric liquid crystals. The determination of the authenticity of the necktie is performed by utilizing this identifying ability. Thus, by utilizing the present invention, an identifying ability having a superior level in the determination of authenticity may be given to an article, without spoiling the conventional design thereof.

In this example, an identification medium shown in FIG. 2 may be directly formed on the fabric of the necktie. That is, an ordinary printed layer 103 and an identification layer 104 may be formed on the fabric that forms the necktie as a substrate, so that an identifying ability is provided to a portion of the necktie. In this case, the identifying ability is provided to the necktie without spoiling the design thereof by utilizing a back fabric of the necktie.

In the present invention, the necktie is exemplified as one of the articles, but a similar composition may be used for other accessories and garments.

### Other Embodiments

A thermochromic ink (thermosensitive ink) may be used as an ink for forming an ordinary printed layer 103. For example, an ordinary printed layer 103 is comprised of a thermochromic ink which changes from black to a transparent state by heating. In this case, the above-described optical function is obtained at ordinary temperature. The ordinary printed layer 103 changes to a transparent state (or semitransparent state) by heating with an iron or an appropriate heating method. As a result, a function as a light absorption layer of the ordinary printed layer 103 is lost (or reduced), and the above optical function is not obtained. An identifying ability of the identification medium 101 is further improved by utilizing this phenomenon.

As another example of the present invention, a structure may be mentioned. In the structure, figures such as predetermined characters, symbols, and patterns are formed on an ordinary printed layer which is comprised of a thermochromic ink or a photochromic ink by heating or irradiating a portion of the figures. Moreover, the overall surface of the ordinary printed layer formed with a predetermined figure is coated with a liquid crystal ink. In this structure, the figure formed by heating or irradiating light allows identification according to a difference of reflection characteristics. In this structure, the figure formed on the ordinary printed layer becomes indistinct by heating or irradiating the overall surface. The determination of the authenticity is performed by utilizing this phenomenon.

As a thermochromic ink that becomes transparent by heating, microencapsulated pigments may be used. The pigment is comprised of a film containing a photopolymerizable composition and an aliphatic amine or an aromatic amine, and the film includes reversible heat allochroic compositions and is ionized by an acid material.

A thermochromic ink which changes from black (dark color) to another color, from another color to black (dark color), and from a transparent state to a predetermined color by heating, may be used, in addition to a thermochromic ink which changes from black to a transparent state.

As an available thermochromic material, a thermochromic ink (trade name: DynaColor, produced by Chromatic Technologies, Inc., United States) may be used.

An ink (photochromic ink), including a photochromic material that changes colors and may be in a transparent state by irradiating light, may be used. In this case, a photochromic layer changes from black to a light-transparent state by irradiating it with ultraviolet light, for example.

A photochromic ink has a property in which a colored state is changed, not by heat, but by light (for example, ultraviolet light). A photochromic ink is similar to the thermochromic ink except that light is used to change the optical characteristics thereof.

A photochromic ink is generally made from material that is photoisomerized by light. As the photochromic ink, azoic dyes, Schiff chlorine materials, and O-nitrobenzene materials may be mentioned.

As an available photochromic ink, a photochromic ink (trade name: DynaColor, produced by Chromatic Technologies, Inc., United States) may be used.

### INDUSTRIAL APPLICABILITY

The present invention may be used in identification media for which the determination of authenticity will be performed by visual inspection.

1. An identification medium comprising:
a woven or nonwoven fabric; and
an identification layer printed by an ink including cholesteric liquid crystals on the fabric.

2. The identification medium according to claim 1, wherein an ordinary printed layer showing a predetermined color is provided between the identification layer and the fabric.

3. The identification medium according to claim 2, wherein the ordinary printed layer functions as a light absorption layer.

4. The identification medium according to claim 2, wherein the ordinary printed layer functions as a flattening layer which moderates an asperity of the fabric.

5. The identification medium according to claim 1, wherein the fabric forms a fabric label.

6. The identification medium according to claim 2, wherein the ordinary printed layer is formed by a thermochromic ink or a photochromic ink.

7. An article provided with the identification medium according to claim 1.
